(19) United States
(12) Patent Application Publication
(10) Pub. No.: US 2009/0019923 A1
(43) Pub. Date: Jan. 22, 2009

(54) Method for measuring octanol-water distribution coefficients of surfactants

(75) Inventor: Dennis Miller, Kelkheim (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 12/217,977

(22) Filed: Jul. 10, 2008

(30) Foreign Application Priority Data
Jul. 10, 2007 (EP) 07013440.8

(51) Int. Cl. G01N 13/02

(52) U.S. Cl. 73/64.48

(57) ABSTRACT

The present invention provides a procedure for determining the octanol-water distribution coefficient P of a surface-active substance by means of the following steps:
1. equilibrating a dilute aqueous solution or dispersion of the substance with octanol
2. evaporating an aliquot of the aqueous phase and re-dissolving the residue in water or electrolyte solution
3. measuring of the surface tension of the re-dissolved residue solution
4. determining the concentration of the surface-active substance in the re-dissolved residue solution by means of a surface tension vs. concentration calibration curve
5. using the concentration of the surface-active substance in the re-dissolved residue solution to calculate the equilibrium concentration in the aqueous phase and, from the mass balance, the equilibrium concentration in the octanol phase
6. calculating the octanol-water distribution coefficient from the ratio of concentrations in octanol and water phases.

The distribution of substances between octanol and water is widely used to help estimate their properties, in particular environmental and toxicological aspects. 1-octanol has been found to be a useful model for animal fat, so that the distribution coefficient is an indication of the tendency of the substance to enter and/or accumulate in fatty tissues. Common uses of Octanol-water distribution coefficients are:
Prediction of bioaccumulation
Prediction of tendency to adsorb on soil and sediments
As a basis for environmental regulations
Screening of pharmacologically active substances
Structure-activity correlations for prediction of toxicological and application properties.

Octanol-water distribution coefficients are routinely used to predict bioaccumulation potential. These predictions can be made on the basis of published literature or via algorithms available as commercial software. These algorithms may use the distribution coefficient either alone or in combination with structural features.

For various regulatory areas, schemes have been devised that classify substances as bioaccumlative or non-bioaccumulative based on the octanol-water distribution coefficient P. In many cases a substance will be classified as bioaccumating if its log P value exceeds a certain limit. Typically log P>3 is taken as an indication of bioaccumulation. For such purposes it is only necessary to show that log P does not exceed the limit; a more accurate value is not required.

Direct measurements of bioaccumulation can only be performed for selected compounds, because they are costly, technically difficult and require the use of live animals.

The octanol-water distribution coefficient is defined as the ratio of the concentrations in the two-phase system at equilibrium:

P=c_{octanol}/c_{water} (1)
c_{octanol}=concentration of substance in octanol
c_{water}=concentration of substance in water

Often the logarithm of P is used, so that the distribution between octanol and water is characterised by the parameter log P (also called log P_{ow} or log K_{ow}).

The environmental profile of a chemical often has a great influence on the commercial potential of products containing it. The absence of reliable data on the octanol-water distribution will generally have an adverse effect on the environmental assessment. As a result, octanol-water distribution coefficients are commercially important for manufacturers, distributors and users of chemicals.

Surfactants have many applications. In the offshore oil industry, for example, they are used as components of corrosion inhibitors, dispersants and demulsifiers. In order to predict bioaccumulation, values of log P are required. However, as described below, current methods do not enable log P values of surfactants to be determined reliably on a routine basis. There is therefore great uncertainty as to how to assess these compounds, and a corresponding need for better methods to determine log P.

### PRIOR ART

A widely used technique for log P determination directly is the shake flask method according to the OECD Guideline for the Testing of Chemicals No. 107 (1995). This involves agitation of the water and octanol phases to achieve equilibrium, followed by analysis of the concentrations in the two phases.

For hydrophobic substances, a slow stirring method is often used in order to prevent errors due to emulsification of the octanol phase in the water according to J. de Bruijn, F. Busser, W Seinen, J Hermens, Environmental Toxicology and Chemistry, 8, 449 (1989).

Another commonly used method is HPLC according to OECD Guideline for the Testing of Chemicals No. 117 (1989). This is based on correlations between retention times and log P values measured by direct methods. There are also several schemes for calculation of log P from the chemical structure. They involve algorithms based on correlations between structural characteristics and experimental values.

For surfactants log P determinations are difficult because of the following problems:
Surface activity leads to emulsification with the shake flask method.
Micelle formation may affect the distribution between water and octanol.
Calculations are unreliable because of insufficient experimental data on which to base the correlation.
Commercial surfactants are typically a mixture of chemically related compounds.

The OECD Guideline 107 recognises that the shake-flask method is inappropriate for surfactants and recommends estimating their log P values from the ratio of solubilities in water and octanol. However, such estimates give, at best, only a rough guide because of the intrinsic limitations of the method and the complex solubility behaviour of surfactants.

The slow stirring method has been proposed for surfactants as method for equilibrating water and octanol phases without emulsification. S. W. Morall, R. R. Herzog, P. Kloepper-Sams, M. J. Rosen, Proc. 4th World Surfactant Congr. (Barcelona), Vol. 3 p. 220-227 (1996) determined the concentration of surfactant chromatographically. US-2003 0 213 069 describes the use of light scattering or mass spectroscopic detectors for this purpose.

Dynamic surface tension has been described as a method of determining the surfactant concentration of washing liquors as described in US Patent 20030213069 and T. Müller-Kirschbaum, E. J. Smulders, SÖFW-Journal, 118, 427-434 (1992).

There was a need for a process of determining P that does not show the disadvantages outlined above.

### SUMMARY OF THE INVENTION

The present invention provides a procedure for determining the octanol-water distribution coefficient P of a surface-active substance by means of the following steps:
1. equilibrating a dilute aqueous solution or dispersion of the substance with octanol
2. evaporating an aliquot of the aqueous phase and re-dissolving the residue in water or electrolyte solution
3. measuring of the surface tension of the re-dissolved residue solution
4. determining the concentration of the surface-active substance in the re-dissolved residue solution by means of a surface tension vs. concentration calibration curve
5. using the concentration of the surface-active substance in the re-dissolved residue solution to calculate the equilibrium concentration in the aqueous phase and, from the mass balance, the equilibrium concentration in the octanol phase
6. calculating the octanol-water distribution coefficient from the ratio of concentrations in octanol and water phases.

The present invention offers an improved method for measuring log P of a water soluble or water dispersible surface active substance. It is suitable for testing commercial surfactants on a routine basis. In some cases, in particular very hydrophilic surfactants, the method may only give a upper limit for log P; as explained above this is often sufficient for regulatory purposes.

Aqueous surfactant solution is equilibrated with octanol. The concentration of surfactant in the aqueous phase after equilibration is determined from the surface tension using a calibration curve. Interference from octanol is prevented by first removing it by evaporation and re-dissolution. The concentration of surfactant in the octanol layer is calculated from the change in concentration in the aqueous layer. Alternatively an aliquot of the octanol layer can be evaporated and re-dissolved in water to determine the concentration directly via surface tension.

### DESCRIPTION OF THE INVENTION

The steps of determining log P of a surface active substance are explained below.

Equilibrating a dilute aqueous solution or dispersion of the test substance with octanol.

Preferably, equal or approximately equal volumes of water and octanol are used. The preferred method is stirring slowly for several hours. The minimum stirring time required will depend on the system and can, if necessary, be determined by running experiments with different stirring times. In general, we have found a stirring time of eight hours to be sufficient. The stirring speed must be kept low enough for there to be two distinct phases during the whole course of the experiment. Other types of agitation (e.g. shaking, rolling, vibration) may also be used, provided they are gentle enough to avoid any mixing of the phases.

Evaporating an aliquot of the aqueous phase and re-dissolving the residue in water or electrolyte solution. This removes octanol, which is surface active and would therefore interefere with the subsequent concentration determination via surface tension. It is covenient to take an aliquot of between 1 and 10 mL and re-dissolve in a larger volume of water (20-500 mL).

Optionally, an electrolyte solution in which the surfactant is soluble may be used for the dilution step. The electrolyte increases the surface activity of the surfactant and hence the sensitivity of the method.

Measuring of the surface tension of the re-dissolved residue solution

The surface tension may be measured by any convenient method, for example, the plate, ring or bubble pressure methods. Preferably a method should be used which allows an equilibration time of several minutes e.g. the plate method.

Determining the concentration of the surface-active substance in the re-dissolved residue solution by means of a surface tension vs. concentration calibration curve.

The calibration curve is obtained by measuring the surface tension of the surfactant at various concentrations. Exactly the same procedure should be used as for the re-dissolved residue solution. If an electrolyte solution is used in the dilution step, it must also be used for the calibration curve.

The curve is fitted using any suitable method, e.g. graphically, or polynomial fit, or using a non-linear fit based on a theoretical equation for surface tension as a function of concentration.

Using the concentration of the surface-active substance in the re-dissolved residue solution to calculate the equilibrium concentration in the aqueous phase. The reduction in the amount of surfactant in the aqueous layer is used to calculate the amount in the octanol layer.

Calculating the octanol-water distribution coefficient from the ratio of concentrations in octanol and water phases.

Step 2 involves dilution of the surfactant before measuring the surface tension. FIG. 1 shows the typical concentration effects on surface tension for a surfactant. The dilution factor should be chosen so that the concentration at which the surface tension is measured lies in the steep part of the curve.

The formula for the calculations in steps 5 and 6 is:

P=V_{aq}(c₀−c_{aq})/(V_{oct}c_{aq}) (2)

Where c₀ is the initial concentration of surfactant in the aqueous phase. V_{aq} and V_{oct} are the volumes of aqueous and octanol phases, respectively.

For surfactants, the measured value of log P may be affected by micelle formation. For many purposes, however, the distribution of non-micellised surfactant is the phenomenon of interest. Micellisation may be corrected for by the following methods:

1) log P is measured at several concentrations and extrapolated to zero concentration.
2) In equation 1 the concentration of non-micellised surfactant is used as the effective concentration in the aqueous phase. The non-micellised surfactant depends on the critical micelle concentration (cmc). Equation (2) is thus modified to give eqn. (3):

P=V_{aq}(c₀−c_{aq})/(V_{oct}c_{non-micellised}) (3)
For cmc<c_{aq} c_{non-micellised}=cmc
For cmc≧c_{aq} c_{non-micellised}=c_{aq}

Critical micelle concentrations may be measured by a variety of techniques described in the literature (e.g. surface tension/concentration curves, solubilisation of hydrophobic dyes, spectral change of water-soluble dyes, fluorescence spectrum of solubilised pyrene, conductivity). In the partition experiment, the presence of octanol in the aqueous layer may affect the cmc. This may be taken into account by measuring the cmc at an octanol concentration corresponding to the saturation concentration in water.

We have found that the above procedure, in which only the concentration of the aqueous phase is measured, gives satisfactory results for water-soluble surfactants. Improved accuracy, and evidence for consistency can be obtained by also measuring the concentration in the octanol layer directly. This is done by evaporating an aliquot, redissolving in water or electrolyte solution, measuring the surface tension and calculating the concentration from a calibration curve.

### EXAMPLES

### Example 1

Substance: C₂₂-amidoamine betaine. The major component of the C-chain distribution is C₂₂-alkenyl.

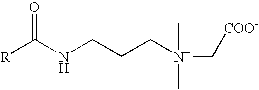

Equilibration experiment: 100 mL of a 1 g/L aqueous solution of the surfactant and 100 mL octanol were placed in a conical flask. The two-phase system was stirred for eight hours on a magnetic stirrer. The stirring speed (100 rpm) was low enough for there to be two distinct layers. After the stirrer was switched off, the system was allowed to stand overnight. Then a 2 mL sample of the aqueous phase was placed in a tensiometer glass and evaporated to dryness in a drying cabinet. The residue was redissolved in 50 mL of 0.2 M KCl. The surface tension of this solution was measured with the Pt plate method. The solution was then diluted five times with 0.2 M KCl and the surface tension measured again. The concentration of surfactant was determined by comparison with a calibration curve. A duplicate experiment was run to check the reproducibility.

FIG. 2 shows the calibration curve. It has the typical form for a micelle-forming surfactant.

Table 1 shows the results. The method shows good reproducibility. Agreement between values obtained with 25× and 125× dilution is evidence of the suitability of this method for determining surfactant concentrations.

TABLE 1
results. From each replicate, A and B, two samples of the
aqueous layer were analysed. The concentration of the re-dissolved
residue solution, cᵣₑ, is calculated from the surface tension via the
calibration curve. The dilution factor is calculated from the volumes used
in the evaporation-redissolution step together with any subsequent dilution.
The concentration in the aqueous layer, c_{aq}, is obtained from cᵣₑ by
multiplying with the dilution factor.

| | | surface. tension. | conc. g/L | | |
|---|---|---|---|---|---|
| sample | Dilution factor | mN/m | Cᵣₑ | C_{aq} | logP |
| A1 | 25 | 37.3 | 0.022 | 0.55 | −0.09 |
| A2 | 25 | 35.1 | 0.025 | 0.63 | −0.22 |
| B1 | 25 | 35.0 | 0.025 | 0.63 | −0.22 |
| B2 | 25 | 35.7 | 0.024 | 0.60 | −0.18 |
| A1 | 125 | 66.1 | 0.00455 | 0.57 | −0.12 |
| A2 | 125 | 65.9 | 0.0047 | 0.59 | −0.15 |
| B1 | 125 | 64.9 | 0.0050 | 0.63 | −0.22 |
| B2 | 125 | 65.6 | 0.0047 | 0.59 | −0.15 |
| | | | | mean | −0.17 |

For an initial concentration in the aqueous layer of 1 g/L, we thus obtain a log P of −0.17. The negative value of log P indicates that the surfactant partitions predominantly into the aqueous layer under these conditions.

### Example 2

Substance: C₁₀-C₁₃ linear alkylbenzene sulfonate (LAS).

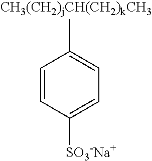

Equilibration experiment: 100 mL of a 1 g/L aqueous solution of the surfactant and 100 mL octanol were placed in a conical flask. The two-phase system was stirred for eight hours on a magnetic stirrer. The stirring speed (100 rpm) was low enough for there to be two distinct layers. After the stirrer was switched off, the system was allowed to stand overnight. Then a 2 mL sample of the aqueous phase was placed in a tensiometer glass evaporated to dryness in a drying cabinet. The residue was redissolved in 50 mL of 0.2 M KCl. The surface tension of this solution was measured with the Pt plate method. The concentration of surfactant was determined by comparison with a calibration curve.

An experimental determination of the critical micelle concentration with the surface tension method gave a value of 1.0 g/L in demineralised water. Literature data (Jonsson et al. in Christian+Scamehorn (editiors), Surf. Sci. Ser. 55, Solubilisation in Surfactant aggregates, p. 138) indicates that if octanol is present at the saturation concentration, the critical micelle concentration of a typical anionic surfactant will be lowered by about a factor of two. We therefor estimate the relevant critical micelle concentration to be 0.5 g/L. In this case the cmc is greater than the concentration in the aqueous layer, so that no micelles are present. Results are shown below.

| | | |
|---|---|---|
| Original concentration in aqueous layer, c₀.: | 1 | g/L |
| Equilibrium concentration in aqueous layer, c_{aq:} | 0.16 | g/L |
| Critical micelle concentration in octanol-saturated water, cmc: | 0.5 | g/L |
| Non-micellised surfactant c_{non-micellised} | 0.16 | g/L |
| Concentation in octanol layer, c₀-c_{aq} | 0.84 | g/L |
| LogP = 0.71 | | |

1. Procedure for determining the octanol-water distribution of a surface-active substance, comprising the steps of:
equilibrating a dilute aqueous solution or dispersion of the surface active substance with octanol to form an aqueous phase;
evaporating an aliquot of the aqueous phase to form a residue and re-dissolving the residue in water or electrolyte solution to form a re-dissolved residue solution;
measuring the surface tension of the re-dissolved residue solution;
determining the concentration of the surface-active substance in the re-dissolved residue solution by means of a surface tension vs. concentration calibration curve;
using the concentration of the surface-active substance in the re-dissolved residue solution to calculate the equilibrium concentration in the aqueous phase and, from the mass balance, the equilibrium concentration in the octanol phase; and
calculating the octanol-water distribution coefficient from the ratio of concentrations in the octanol and water phases.

2. Procedure for determining the octanol-water distribution of a surface-active substance, comprising the steps of:
equilibrating a dilute aqueous solution or dispersion of the surface active substance with octanol to form aliquots of aqueous and octanol phases;
evaporating the aliquots of aqueous and octanol phases to for residues, and re-dissolving the residues in water or electrolyte solution to form re-dissolved residue solutions:
measuring the surface tension of the re-dissolved residue solutions;
determining the concentration of the surface-active substance in the re-dissolved residue solutions by means of a surface tension vs. concentration calibration curves
using the concentration of the surface-active substance in the re-dissolved residue solutions to calculate the equilibrium concentration in the aqueous and octanol phases; and
calculating an octanol-water distribution coefficient from the ratio of concentrations in the octanol and aqueous phases.

3. Procedure according to claim 1, wherein the equilibrating step is carried out by slow stirring of the dilute aqueous solution or dispersion of the surface active substance with octanol.

4. Procedure according to claim 1, wherein the volume ratio of octanol to water is between 1:10 and 10:1.

5. Procedure according to claim 1, wherein the electrolyte solution used for re-dissolving is a KCl solution with a concentration between 0.05 and 0.5 Mol/L.

6. Procedure for determining the octanol-water distribution for non-micellised surfactant comprising the steps of:
determining the octanol-water distribution coefficient according to claim 1 for several initial concentrations; and
extrapolating the octanol-water distribution coefficient to an initial concentration of zero.

7. Procedure for determining the octanol-water distribution for a non-micellised surfactant comprising the steps of:
determining the equilibrium concentrations in the octanol and aqueous phases according to claim 1;
determining the critical micelle concentration of the non-micellised surfactant in water; and
calculating the octanol-water distribution coefficient from
a) the ratio of concentrations in octanol to the critical micelle concentration, if the critical micelle concentration is less than the equilibrium concentration in the aqueous phase
b) the ratio of concentration in octanol to the equilibrium concentration in the aqueous phase, if the critical micelle concentration is not less than the equilibrium concentration in the aqueous phase.

8. Procedure for estimating or predicting the bioaccumulation potential of a surface active substance comprising the step of employing the procedure according to claim 1.

9. Procedure according to claim 1, wherein the volume ratio of octanol to water is between 1:2 and 2:1.

10. Procedure according to claim 1, wherein the surface active is a commercial surfactant.

11. Procedure according to claim 2, wherein the surface active is a commercial surfactant.

12. Procedure according to claim 7, wherein the determining the critical micelle concentration of the non-micellised surfactant in water step occurs at an octanol concentration corresponding to the saturation concentration in water.
